(19) United States
(12) Patent Application Publication
(10) Pub. No.: US 2015/0149512 A1
(43) Pub. Date: May 28, 2015

(54) Integrated Desktop Software for Management of Virus Data

(71) Applicant: Gataca, LLC, Newport, VA (US)

(72) Inventors: Johanna Craig, Newport, VA (US); Julian Capps, Austin, TX (US)

(21) Appl. No.: 14/611,094

(22) Filed: Jan. 30, 2015

Related U.S. Application Data
(63) Continuation of application No. 12/687,816, filed on Jan. 14, 2010, now abandoned.
(60) Provisional application No. 61/205,033, filed on Jan. 14, 2009.

(51) Int. Cl. G06F 17/30

(52) U.S. Cl. CPC G06F 17/30289
USPC 707/805

(57) ABSTRACT

A system and method for managing virus data may include software tailored for rapid, efficient and flexible management of virus data. The system may easier overcome data management problems. Moreover, the system may streamline the serious bottleneck of data management, significantly compressing time between data collection and cure discovery. The system may comprise graphical-user interface (GU I) tools and a data-storage and retrieval system. It may also include a commercial relational database engine. The system may include annotation, alignment, phylogenetics and mutation analysis tools. The alignment tool may be linked to a query tool and include a contig assembler. The system may include mutation tracking, report generation and entropy measurement tools, as well as statistical routines and security and installation packages. The system may include a software architecture comprised of three tiers: a presentation (GUI) tier, a middleware (Domain) tier, and a relational database management system (RDBMS) tier.

### CROSS-REFERENCE TO RELATED APPLICATIONS

This application is a continuation of U.S. patent application Ser. No. 12/687,816, filed Jan. 14, 2010, which claims the benefit of U.S. Provisional Application No. 61/205,033, filed Jan. 14, 2009, each of which are incorporated herein by reference in their entirety.

### BACKGROUND OF THE INVENTION

This invention relates in general to a system and a method for management of virus data, including hepatitis C data.

The hepatitis C virus (HCV), in particular, infects approximately 4 million people in the United States and is the leading cause of chronic liver disease. HCV-related end-stage liver disease is now a leading cause of death among HIV positive patients. HCV pathology includes fibrosis, cirrhosis and hepatocellular carcinoma. The hepatitis C virus is difficult to study and not effectively treated with anti-viral drugs, with fewer than 50% responding favorably to the current therapies; and efficacious options are still years away.

HCV is enveloped and contains a plus-strand RNA of 9 kb. The RNA genome carries a single open reading frame (ORF) encoding a polyprotein that is proteolytically cleaved into a set of 10 distinct products (see FIG. 1, wherein diamonds designate cleavage points) which comprise the viral particle and the viral replication machinery. The 5′ untranslated region directs translation of the HCV ORF via its binding of cellular ribosomes and proteins. HCV infects macrophages and hepatocytes and unlike the retroviruses, does not integrate into the host genome.

Mutations accumulate in regions along the HCV genome constituting mutation hotspots. These hypervariable regions are concentrated in five areas that include the NS5B protein, areas within and between the E1 and E2 proteins, and in the core protein. HCV has six identified genotypes and over 50 HCV subtypes that vary from one another in their nucleotide sequences by 31-35%.

HCV proteins mutate readily, leading to drug resistance. HCV is a remarkably successful pathogen. It has the ability to evade host immune responses, which it accomplishes by replicating rapidly and encouraging mutations via an error-prone HCV RNA-dependent polymerase that lacks proofreading capabilities. When HCV infects a patient, new variants (quasi- species, varying from one another in their sequences by 1-9%) arise continuously from the predominant infecting genotype during viral replication, resulting in hundreds of heterologous HCV genomes. The most fit of these variants are selected continuously in the replication environment on the basis of their replication capacities and selection pressures, including anti-viral drug pressures. At a given time during infection, the HCV quasi-species distribution reflects a balance among the continuous generation of new variants, the need to conserve essential viral functions, and positive selection pressures exerted by the replicative environment. Thus, HCV infection sets up a complex problem for drug design, as scientists try to track HCV genetic variation over time, between transmission of the virus, and after treatment with therapeutic drugs.

HCV infection presents a distinct set of analysis problems. The high mutation rate of HCV results in the accumulation of vast numbers of new genetic sequences and associated biological data in the daily conduct of laboratory research and clinical trials. Data management is a continuous problem. Investigators currently rely upon homespun databases, generic software products, and tools from public web repositories to sort, organize and analyze their genomic and biological data. Table 1 (below) displays nine steps that are routinely carried out to organize and analyze HCV sequence data (left column). The right column displays the corresponding programs or manual steps that are commonly used to manage this data.

TABLE 1

| Routine Activity | Software and/or Manual Steps |
|---|---|
| Genotyping | 1. MacVector |
| | 2. Mutation Surveyor |
| | 3. BioEdit |
| Editing | 1. Manually |
| | 2. BioEdit |
| | 3. Mutation Surveyor |
| Alignments | 1. MacVector |
| | 2. Mutation Surveyor |
| | 3. BioEdit |
| Translation | 1. LaserGene |
| | 2. Mutation Surveyor |
| Mutation survey | 1. Mutation Surveyor |
| Annotating | 1. Manual |
| Phylogenetic Analysis | 1. MacVector |
| | 2. Public Databases (Los Alamos, Stanford) |
| Querying | 1. LaserGene |
| | 2. Public Databases (Los Alamos) |
| | 3. In-house database |
| Graphics | 1. Excel |
| | 2. PowerPoint |
| | 3. Illustrator |
| | 4. Prism |

In the Research Laboratory, a postdoctoral fellow will conduct research and manage the data that is produced. Consider a project that involves a daily routine of selecting 100 HCV clones for sequencing per day (i.e. 500-600 clones per week). Each day the new sequences are stored on a server or in folder files on computer desktops, and a series of routine actions is performed on the sequences (Table 1). It is not unusual for the data from several days work to accumulate and present extremely difficult to overwhelming data-management problems that cause the project to bog down.

In the industry, trials often involve thousands of patients. Blood- draws on 1,000-2,000 patients/week require 1,000-2,000 sequences be generated per week or about 200/day. Data management is an ongoing problem. The routine actions performed daily on the sequences are similar to those required in the research lab (see Table 1). One or several full time people are typically assigned to managing the data that accumulates.

The high mutation rate of HCV results in vast numbers of new genetic sequences and associated biological data in the daily conduct of laboratory research and clinical trials with attendant serious data management problems. Investigators currently rely upon homespun databases, generic software products, and tools from public web repositories to sort, organize and analyze their genomic and biological data. These tools are often specific to certain hardware or software configurations. These tools are not tailored to the HCV genome and moving data from one program to the next is labor intensive, time consuming, and vulnerable to error.

### SUMMARY

This invention relates to a system and a method for management of virus data, including hepatitis C data. The system may include desktop software tailored for the rapid, efficient and flexible management of virus data, including HCV data. The system may make it easier for scientists to overcome data management problems. Moreover, the system may streamline the serious bottleneck of data management, significantly compressing the time between data collection and cure discovery.

The system may be comprised of graphical-user interface (GUI) tools and a data-storage and retrieval system (DSRS) that may be designed specifically for analysis of a particular virus (e.g. HCV). It may also include a commercial relational database engine.

The system may include an annotation tool which may simplify the capture, storage and management of crucial experimental data points, and bring these user defined data points (annotations) into the same searchable context as those that are inherently systemic and structured.

The system may further include alignment, phylogenetics and mutation analysis tools that may be specifically tailored to the mathematics of the virus's (e.g. HCV's) replication rate and its mutation genesis points (e.g. error-prone polymerase).

The system may include a software architecture that is comprised of three tiers: a presentation (GUI) tier, a middleware (Domain) tier, and a relational database management system (RDBMS) tier.

The alignment tool may be linked to a query tool and include a contig assembler for analyzing complete and partial genomic sequences. The phylogeny tool may assemble alignments into evolutionary trees that can color-code and time-stamp the input sequences. A graphics tool may present the raw electropherogram data (traces), and assemble line and bar graphs to plot variables.

The system may include additional tools for mutation tracking, report generation and entropy measurement, as well as statistical routines and security and installation packages.

The system may merge informatics with basic research for rapid discovery. The system may aid in the rapidly developing market of HCV research. As a result, the system may greatly improve analysis capabilities and reduce data processing time. The system may also promote basic research in the field of bioinformatics and information sciences, and lead to enormous public benefit.

The system may incorporate an N Tier structure that allows for the software to be easily scaled across disparate hardware resources without the need to retool. For example, individual tiers can be implemented on various different machines each running different operating systems, yet the overall system is still able to communicate and process the virus data effectively.

Various advantages of this invention will become apparent to those skilled in the art from the following detailed description of the preferred embodiment, when read in light of the accompanying drawings.

### BRIEF DESCRIPTION OF THE DRAWINGS

FIG. 1 is a diagrammatic representation of the HCV genome.

FIG. 2 is a diagrammatic representation of parts of an exemplary system for management of virus data.

FIG. 3 is a diagrammatic representation of an exemplary tool set for management of virus data.

FIG. 4 shows an exemplary application architecture.

FIG. 5 shows an exemplary import tool.

FIG. 6 shows an exemplary data manager window.

FIGS. 7 and 8 show a hierarchical folder and file structures.

FIG. 9 shows windows of an exemplary annotation tool.

FIG. 10 shows an exemplary editing screen.

FIG. 11 shows an exemplary query designer window and an exemplary query results window.

FIG. 12 shows exemplary windows of a query tool.

FIG. 13 shows a diagrammatic representation of an exemplary alignment tool.

FIG. 14 shows a diagrammatic representation of an exemplary Contig Assembly Tool.

FIG. 15 shows a diagrammatic representation of an exemplary Phylogeny Tree Tool.

FIG. 16 shows a diagrammatic representation of an exemplary tiered architecture embodiment.

FIG. 17 shows a diagrammatic representation of an exemplary Trace Viewer Tool.

FIG. 18 shows a diagrammatic representation of an exemplary Graph Tool.

### DETAILED DESCRIPTION

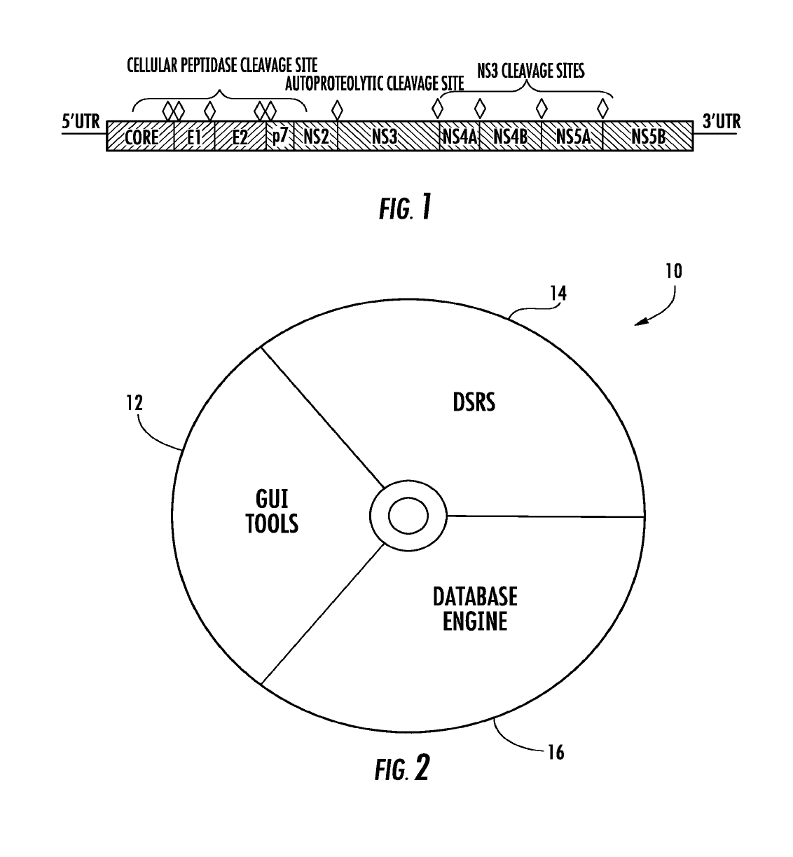

Now with reference to FIG. 2, there is illustrated an exemplary system that may address and overcome the major data-management problems that are routinely encountered in working with viruses, such as HCV. The system 10 may be comprised of graphical-user interface (GUI) tools 12 (e.g., graphical icons and visual indicators that represent the information and actions available to a user) and a data-storage and retrieval system (DSRS) 14, which may both be designed specifically for HCV analysis, or the analysis of other viruses. The system 10 may also include a commercial relational database engine 16 (e.g., a software component that may be used to create, retrieve, update and delete (CRUD) data). These components may enable the integration, analysis and storage of genetic, biological, clinical and phenotypic data, and the capacity to query that data (see below).

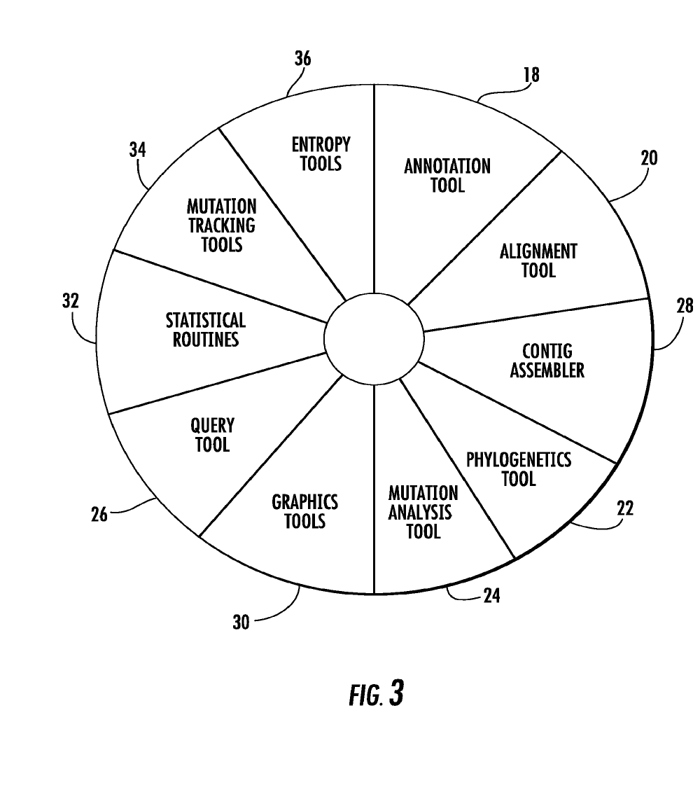

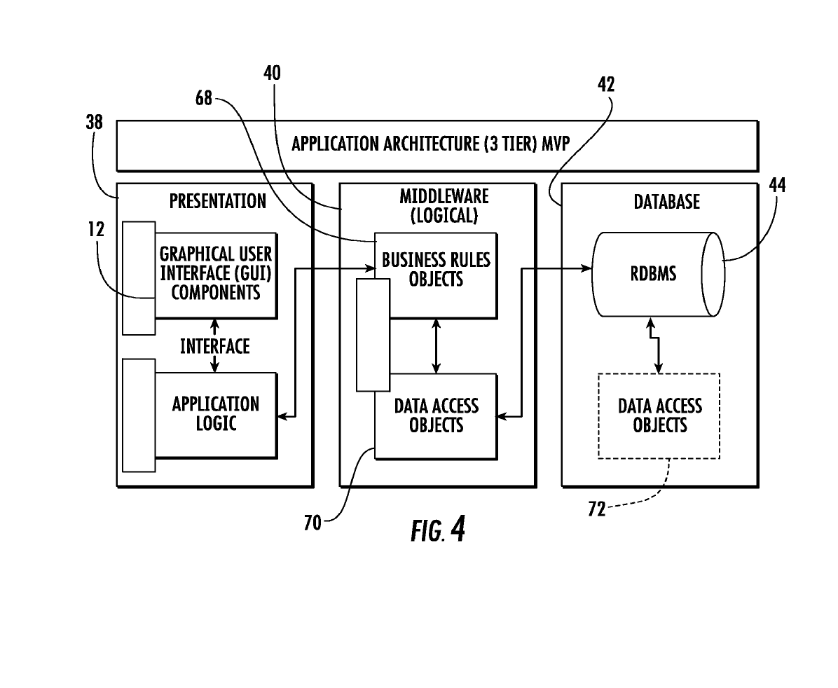

As shown in FIG. 3, the system may be comprised of various tools. The system shown includes an annotation tool 18, which may simplify the capture, storage and management of crucial experimental data points, and brings these user-defined data points (annotations) into the same searchable context as those that are inherently systemic and structured. Additionally, the annotation tool 18 may simplify the Data Manipulation Language (DML) for retrieving those data. As a result, the user may have unparalleled data-mining and analysis flexibility of high dimensionality data sets. Virus sequences, including HCV sequences, may be associated with many measured biological parameters, such as viral load, anti-viral inhibitor, cell line, length of experiment, liver enzyme profile, etc. Thus, the sequences may have a high dimensionality that is unique to the virus (e.g., HCV). These biological parameters may follow each sequence through storage and manipulation (currently HCV biologists attach and tend to these rider notes manually). It should be noted that alignment, phylogenetics and mutation analysis tools 20, 22, 24 may be specifically tailored to the mathematics of a virus (e.g., HCV) replication rate and mutation genesis points (e.g. error-prone polymerase). The combination of these tools 20, 22, 24 in one place may greatly streamline the data management and manipulation problems so that the virologist can conduct his/her research in a more effective fashion.

The alignment tool 20 may be linked to a query tool 26, which may be an existing query tool. The alignment tool 20 may include a contig assembler 28 for assembling genomic sequence fragments into virus (e.g., HCV) consensus sequences. The alignment tool 20 may suppress false mutation predictions arising from technical error or misalignment, and iteratively improve alignments in the nucleotide and amino acid sequences (e.g., in the five HCV hypervariable regions (see FIG. 1) that are interspersed between the conserved regions). It may accomplish this with specialized sequence anchors and modified algorithms that may calculate distances based upon the cumulative mutations from baseline within these regions. The phylogeny tool 22 may be provided for, among other uses, assembling these specialized alignments into evolutionary trees, and color-coding and time- stamping the input sequences, for example, based on desired result sets, such as according to quasi-species from single patient or clonal samples. A graphics tool 30 may present the raw electropherogram data (traces), and assemble line and bar graphs to plot variables.

Additional tools may be provided for mutation tracking, entropy measurement and report generation. The system 10 may also include statistical routines 32, and security and installation packages. Together, the phylogeny tool 22, mutation tracking and entropy tools 34, 36 and statistical procedures 32 may quantify the degree of virus variation within and among quasi-species sequences, for example, by calculating the nucleotide and amino acid sequence mutation profiles (diversity), entropy (complexity) and the genetic distances (divergence). The mutation tracking tool 34 may be linked to the phylogeny tool 22 for determining the evolutionary rate of the mutation types and the contribution of recombination to quasi-species diversity and to the adaptive evolution of the virus (e.g., HCV) under environmental pressures.

The statistical routines 32 may formulate output from the phylogeny tool 22, mutation and entropy tools 24, 36 to compute virus (e.g., HCV) genetic variability. Used in conjunction with the annotation and query tools 18, 26, these tools 32, 34, 36 may enable researchers to conduct crucial analyses regarding genotype sensitivity to anti-viral drugs, including: 1) investigating quasi-species distributions and virus eradication, 2) comparing genetic heterogeneity among anti-viral responders and non-responders, and 3) asking whether virus (e.g., HCV) quasi-species shuffle resistance mutations within or among virus genes to increase diversity to drug resistant genotypes. The statistical routines 32 may also include formulas, for example, for calculating the covariance of the infecting genotypes to determine whether a change in a nucleotide or amino acid at position A affects a mutation or recombination at position B in a given sequence.

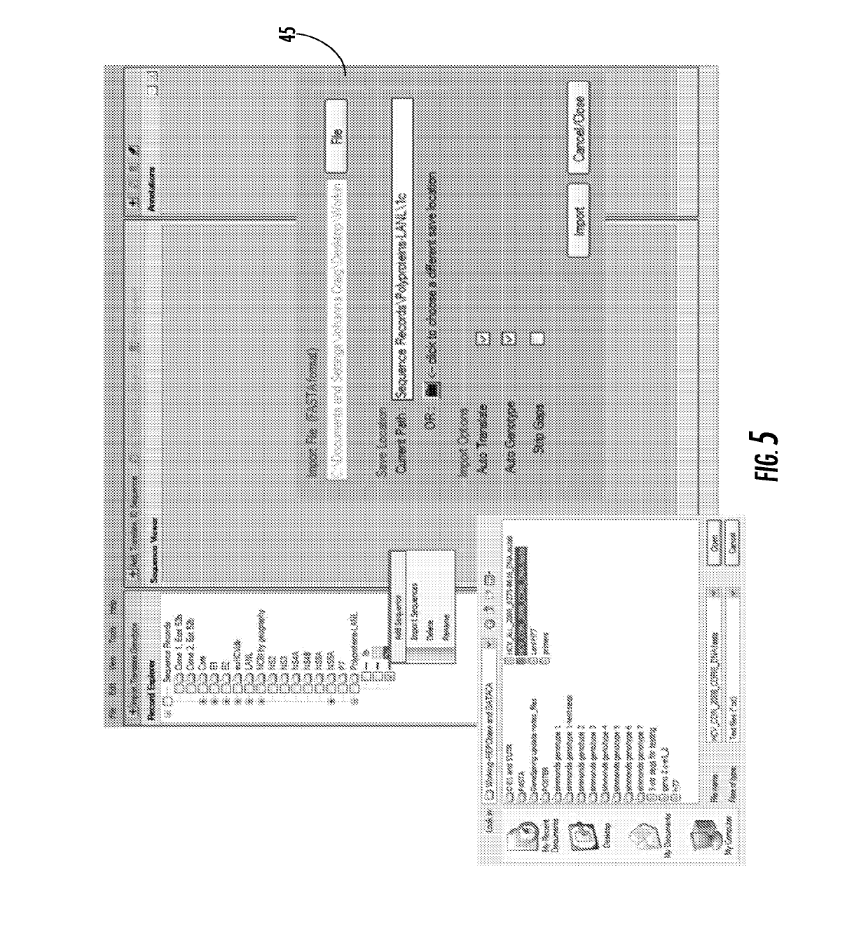

The exemplary system 10 may be comprised of software components that facilitate the storage, integration and analysis of genetic, clinical and phenotypic data and have the capacity to query that data. For example, as illustrated in FIG. 4, the software architecture may be comprised of presentation, middleware/logical, and database tiers 38, 40, 42 with interaction object layers. For example, these tiers may be comprised of GUI, middleware, and data components. GUI components may include forms (e.g., windows forms) that may be served to the user from a presentation tier as GUI tools 12 with which the user may interact. GUI components may take input from the user and display results. Middleware components may house the processing logic (e.g., methods) used by the system 10 to process input and return output to GUI components (e.g., GUI objects). Middleware components (e.g., middleware objects) may interact with the database components, for example, by preparing and transmitting data for storage and retrieving data from the database components. The database tier may include a Relational Database Management System (RDBMS) 44 for persistent data storage, and a data model. The software architecture is described in greater detail in the description herein below.

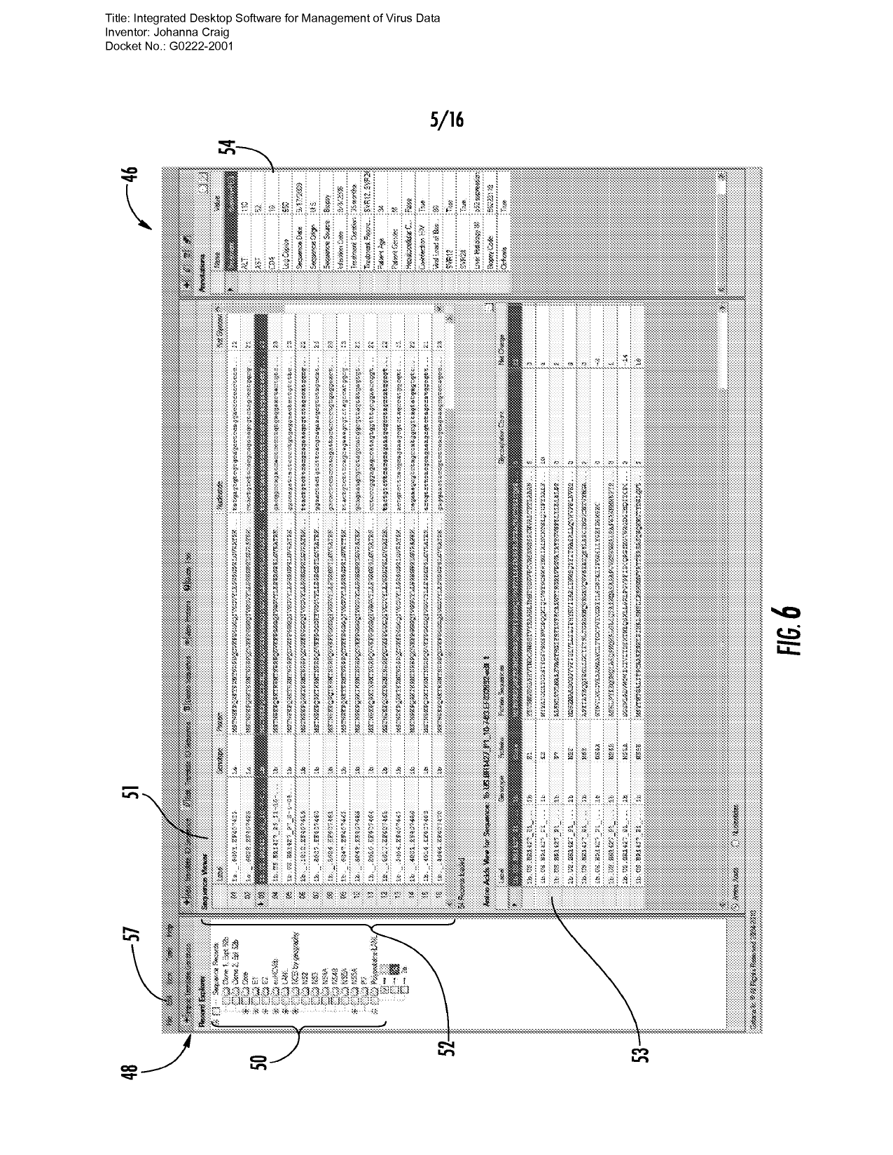

Entering sequences may be easily accomplished via multiple options during a user session. Virus sequences may be entered into the system 10, for example, through any suitable data entry tool capable entering virus sequences or virus sequence data. It should be appreciated that sequences may be submitted to the system 10 in bulk using a bulk sequence import tool. An exemplary import tool 45 is shown in the center of FIG. 5. Import tool may be configurable to allow incoming sequences to be left alone as a raw imported data or be automatically processed in some way, such as being automatically translated, or being automatically identified. A suitable tool may be designed to accept genetic sequences as individual files, FASTA format files, or any other suitable data sources. This permits live import of data from a sequencing device or machine. The sequencing machine can be directly connected to the system or software, or the software can be incorporated in the sequencing device or machine, without generating files. The tool may also be designed to accept various types of sequences, such as nucleic acid (ntd) or amino acid (aa) sequences. The user can choose to genotype, translate and identify complete and partial virus (e.g., HCV) proteins using a sequence identifier (see FIG. 5). An exemplary sequence translator tool may translate nucleic acid into amino acid sequence data. An exemplary sequence identifier may be in the form of a tool comprised of algorithms used to identify all known virus (e.g. HCV) genotypes and subtypes. Upon sequence entry, the system 10 may automatically calculate the net charges of proteins and tally all glycosylation and phosphorylation sites. Genotyping and translation may be presented as options to the user.

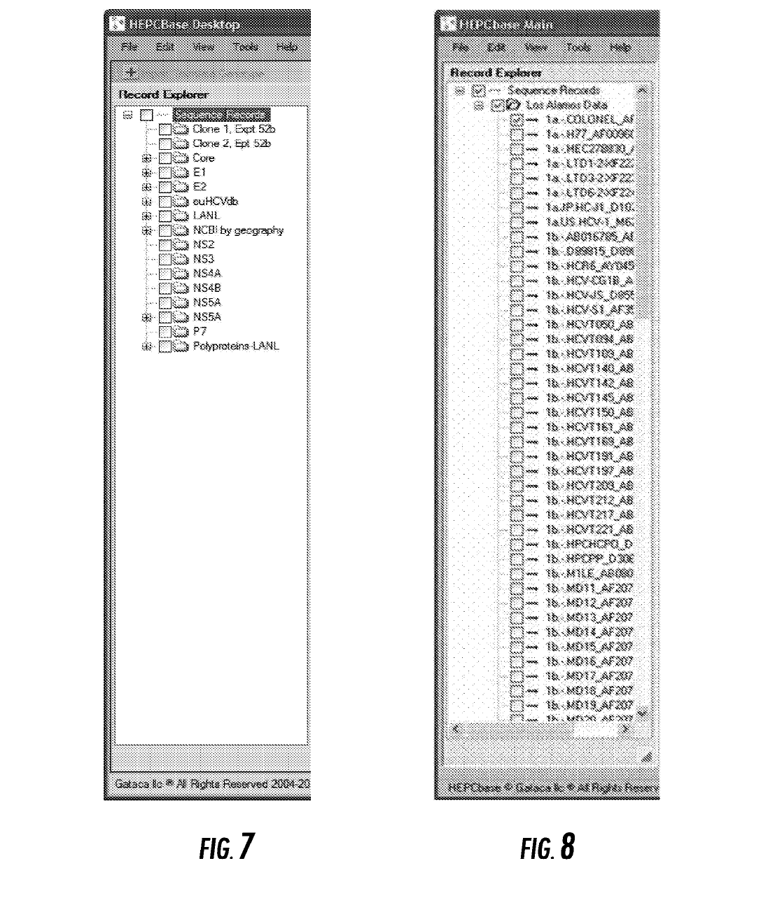

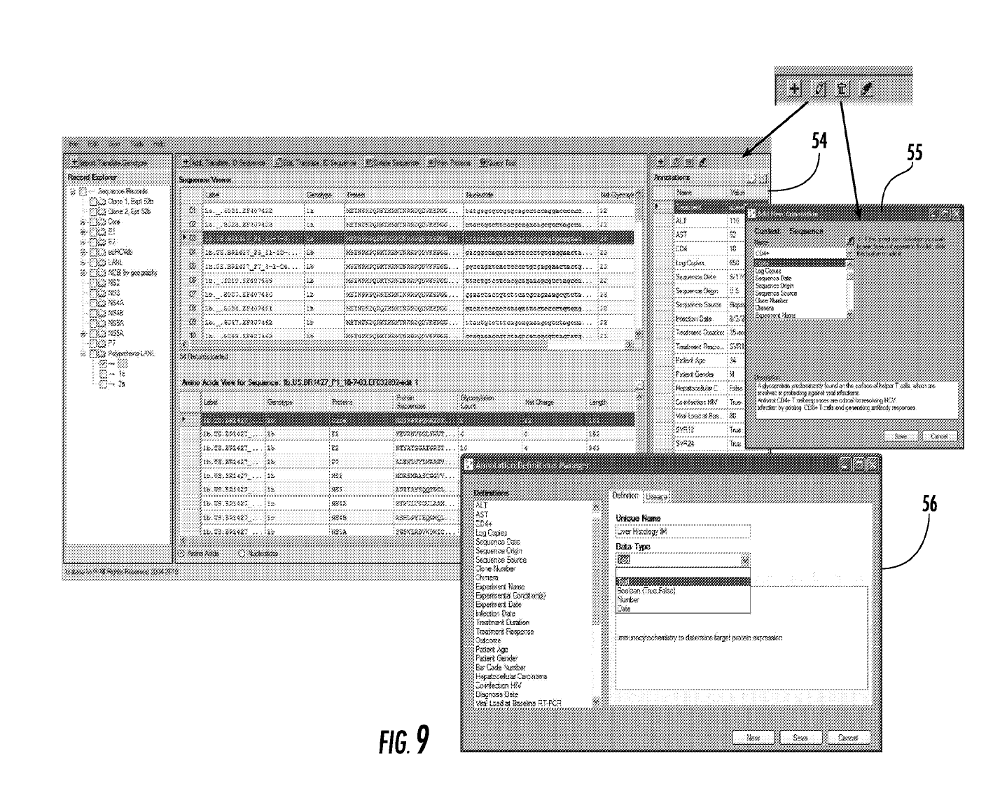

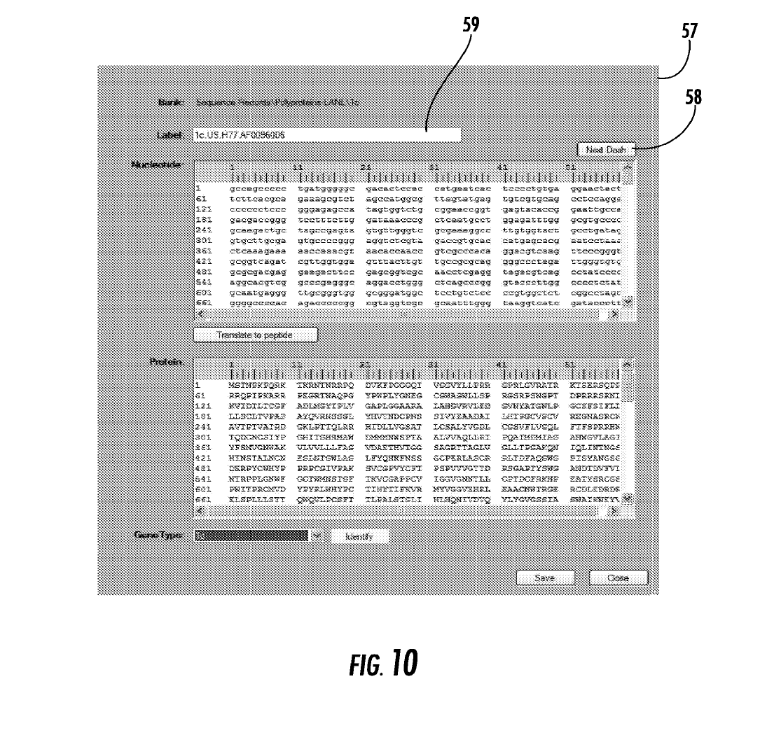

In FIG. 6, there is illustrated an exemplary data manager tool (e.g., window 46), which may be seen by a user after entering sequences. The data manager window 46 may comprise a record explorer 48 that may include a flexible leaf and node/tree type organizer 50 that may allow users to easily manage their sequence data. Users can create hierarchical file and folder structures (see FIGS. 7 and 8) into which they may load various objects, including but not limited to sequence banks, alignment results, traces, and query results.

The exemplary system 10 may further include a sequence viewer tool 51 (e.g., a display and editing tool that allows users to view stored sequences). Users may select single or multiple banks of sequences 52 for display. Once displayed, various options may be available for working with selected sequences, such as editing, annotating, constituent protein view or nucleotide region view. New sequences may be added to a target sequence bank or multiple sequences may be chosen for alignment. This is the general workspace where users may manipulate and view the sequences stored within their sequence banks The system 10 may allow for various tools to be utilized from within this and other workspaces.

By highlighting a sequence in the sequence viewer 51 (as shown in FIG. 6), the user can view the individual proteins identified within that sequence in the region/protein viewer screen 53 (shown in the bottom panel of the data manager window 46 when in FIG. 6). The region/protein viewer 53 may be capable of displaying nucleotide and or protein sequences as segmented into their constituent proteins or regions, respectively. Single sequences may be chosen from the sequence viewer for display within this tool. Users may toggle between protein and nucleotide region views. The system 10 may permit nucleic acid coding regions and proteins to be related to the raw data. The user can choose various options from menu items for sequence editing, translation, genotyping, annotating, saving or deleting, as will become more apparent in the description below. Although the data manager 46 may function as a graphical user interface (GUI), whereby users may interact with the system, a non-graphical data manager may be implemented separately or in combination with the GUI.

User-defined annotations can also be linked to single or multiple sequences with the annotation tool 18 (see the annotation screen 54 to the upper right of the data manager window 46 when in FIG. 6). The annotation tool 18 may act as a user defined data submission tool that allows users to view and attach data entries to sequences for reference. Standard and user-defined annotations may be linked to the sequences at anytime during a session. The annotation screen 54 may allow users to create definitions for values or text representing clinical, experimental, and/or biological data they would like to link to their genetic data. This user-defined annotation system may allow researchers to easily comply with patient confidentially and HIPPA standards because they may choose how they store their collected information.

The user can select to add annotations to sequences at anytime during a session. Annotations already defined in the system may be attached to a sequence for selection items as shown the Add New Annotation window 55 (the right panel when viewing FIG. 9). New annotations can be created in the Annotations Definition Manager 56 (the lower panel when viewing FIG. 9). The user may enter the annotation name, defines the type of annotation in a drop-down menu and can choose whether the annotation is restricted to certain values. Exemplary embodiments of the system 10 may allow annotations to take virtually any form, including text, numbers, images, hyperlinks, file associations, or other useful data. The ability to define an annotation with great precision allows for complex searches using the query tool 26.

Users may choose the sequences they wish to annotate and do so within the annotation tool 18, which may be displayed next to the sequence viewer for convenience. Annotations are searchable. The Annotations Definition Manager 56 may allow users to pre-define labels and associated data types for customized annotations (e.g. patient ID, biopsy type, sequence dates, etc.). The annotation tool 18 may also allow users to customize functionality, e.g. to find and return special patterns in certain positions within a sequence. The annotation tool 18 may further allow users to view, add new, and edit existing annotations for individual sequences or sequence sets.

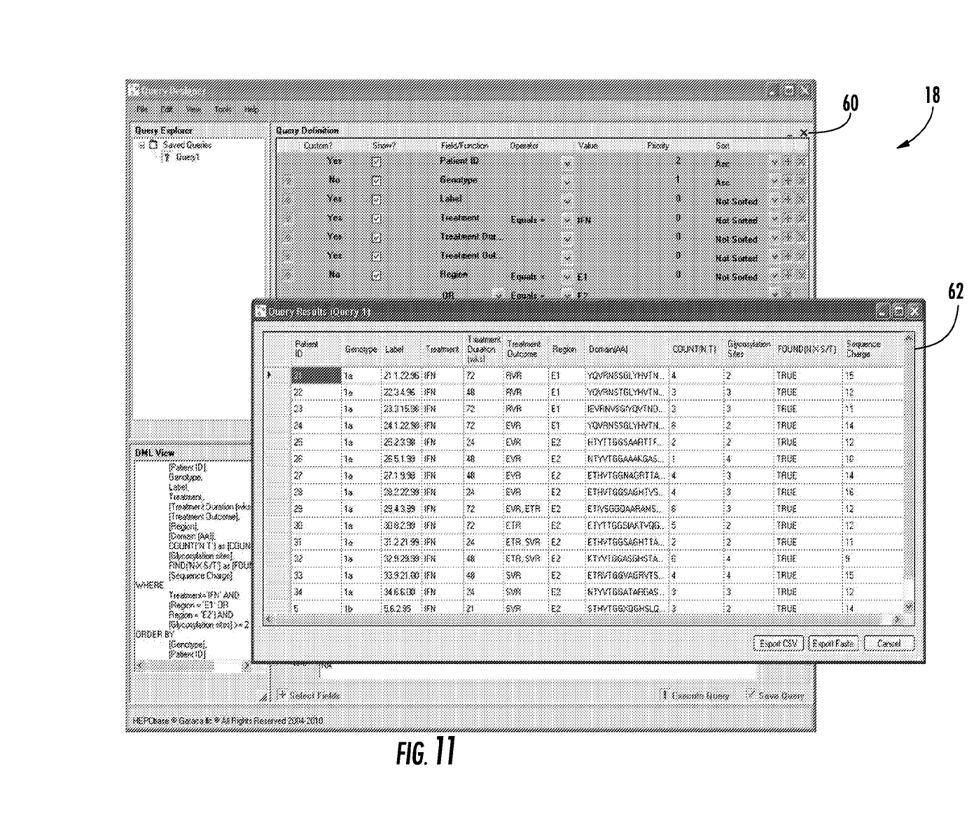

Clicking on any of the edit sequence menu items, from the edit menu 57 (shown in FIG. 6), or the edit tool icon (not shown), may reveal the intended sequence for editing, translating or re-translating, genotyping and saving. An exemplary sequence editor tool 57 is shown in FIG. 10. The sequence editing tool 57 may allow a user to add and edit sequence data. The “next dash” button 58 may jump the cursor easily from dash to dash, eliminating manual editing repetition. This window may also enable single sequence entry, by simply pasting a FASTA-formatted sequence (ntd or aa) into the appropriate window. The FASTA sequence label may be automatically parsed into a “Label” box 59.

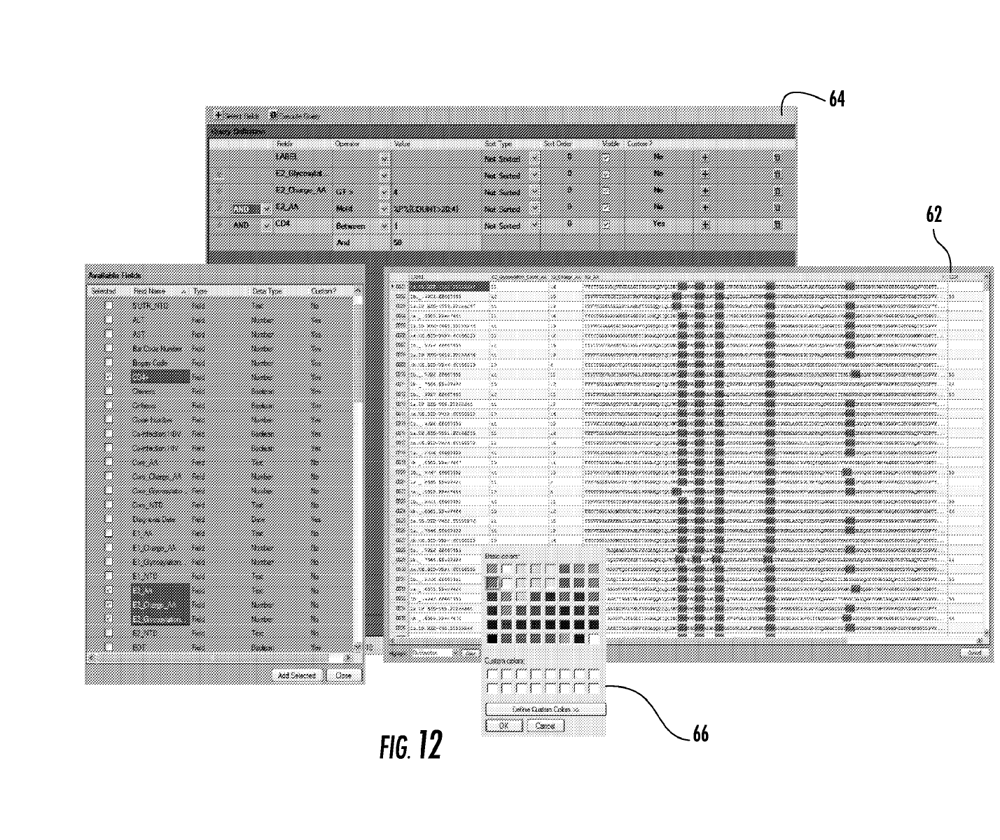

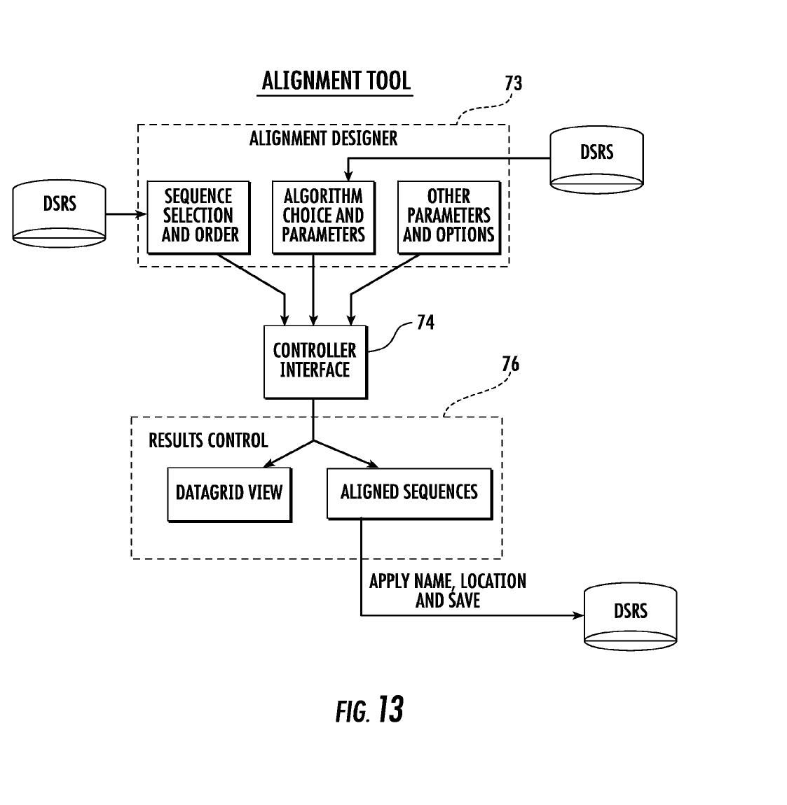

The linkage of virus (e.g., HCV) genomic, clinical and experimental data provides the system 10 with advanced query power. An exemplary query tool 26 is shown in FIGS. 11 and 12. The query tool 26 may include a query designer window 60 and a results or reporting window 62. The designer window 60 allows the user to select attributes, such as treatment response, number of glycosylation sites, and sequence charge. Easily designed queries, directed at relational data sets, may aid in identifying and correlating specific genetic virus changes with therapeutic, biological, demographic, and clinical features. Users can isolate sets of information via user-defined genetic characteristics (modify searches, region ID) or via sequence-associated annotations.

Query results may be reported in the results window 62. The results window 62 may provide an easy view of retrieved data. In the example shown, the results window 62 shows treatment duration, response outcome and number of glycosylation sites located for the E1 and E2 domains. Query results may be aligned with the alignment tool 18 or run through another tool in the system 10 for advanced analysis. Using the annotation tool 18, a user may search and annotate their sequences for these special post-translational modified sites, which enabled this exemplary query.

From the results window 62, the user may ask for the calculations of the percentages of variation at any position in the alignment. Right clicking on a sequence may bring up the sequence editor tool 52 so that either the sequences or annotations, or both, may be edited. The results window 62 may be exported into various formats, such as an Excel file, or sent to the alignment tool 20 (e.g., by right clicking)

The query tool 26 may allow users to mine their sequence data limited only by their annotations. This tool may be embodied in a user friendly point-and-click interface for defining query parameters and output fields to facilitate reporting and mining of sequence data. Users may choose from lists of fields inherent in the default data structure, but may also search custom fields (annotations) as defined by the user in the annotation tool 18. Query results may be displayed in various formats, such as grid format and may be exported in various formats, such as CVS or FASTA, as appropriate.

An exemplary use of the query tool 26 is as follows. A user may wish to examine a preliminary correlation between viral infectivity and immune function. Viral envelope proteins play key roles in host cell tropism, infectivity and immune response. A positive charge level on HCV E2 may enhance viral infectivity, the number of proline residues impact E2 alpha helix formation and thus viral entry, while lowered CD4+ counts suggest a declining immune function and progression of HCV infection.

To examine the aforementioned correlation, the user may query the system 10 to i) locate all E2 sequences with an aa charge greater than (>) 4, CD4+ counts between 1 and 55 and a proline count >20 (see the operator selection panel 64 in FIG. 12) and ii) retrieve all E2 aa sequence data, E2 charge and glycosylation counts, patient ID numbers and CD4+counts in the result set. This simple query may produce a result set (shown in the results window 62 in FIG. 12) that allows the researcher to correlate sequences associated with cell tropism to a disease progression parameter. All motifs and special region counts, such as glycosylation and phosphorylation sites, can be highlighted, for example, using the highlighting tool 66 (shown as the lower panel in FIG. 12).

Queries can be saved and annotated as needed. The alignment tool 20 may be linked to the query tool 18, enabling all associated query attributes to be highlighted in the alignment.

Now with reference back to FIG. 4, there is illustrated middleware 40 (i.e., a domain layer), which may be comprised of a plurality of logical layers. In an exemplary system 10, the middleware 40 may comprised of two layers. One is for processing domain logic and is called “business rules” 68. This logical layer 68 may reside between the presentation and data access layers 70 and may be responsible for processing requests from and to the presentation layer and from and to the data access layer 70. All classes that exist in the business rules 68 may have complementary classes in the data access layer where applicable. The data access layer 70 may exist between the domain logic layer 68 and the RDBMS 44 and may be called “Data Access.” The data access layer 70 may include all classes responsible for requesting data from and submitting data to the RDBMS system 44. All classes that exist in the Data Access layer 70 may have a complimentary class in the Business Rules layer 68 as well as complementary tables in the data model 72, described herein below.

A Database (RDBMS) 44 may be used for persistent storage of application data. It may comprise a third party relational database management system (RDBMS) and a data model 72. The data model 72 may define table entities whose interdependencies are defined via primary and foreign key relationships. The model 72 may contain entities that contain sequences, annotations, reference sequences and supplemental data (genotype lookups, annotation data types, etc.). An exemplary RDBMS 44 may use a freeware version of Microsoft SQL Server 2005 express.

An exemplary system 10, as described above, may utilize the following technology.
Software:
   Application Framework: Microsoft ASP .NET
   Languages:
      VB .Net: View and Presenter objects
      C# .Net: Business Rules and Data Access objects
      C++: 3rd party algorithm integration
   Windows Forms .NET: Presentation
   T-SQL: Tree View data harvesting stored procedures
   XML: Tree View presentation schema
   SQL: DDL and DML
   RDBMS (Microsoft SQL Server 2005 Express)
   IDE (Microsoft Visual Studio .NET 2005)
Hardware:
   Memory: 2 g DDL Ram
   CPU: 1 g Pentium
   Hard Drive: 80 g 7800 rpm Seagate

As mentioned above, the system 10 may use an N Tier architecture approach comprised of presentation, middleware, and relational database system (persistent data store) tiers. The presentation tier 38 may be comprised of view components, such as the GUI tools 12 (e.g., windows forms), and presenter classes (e.g., event handlers and logical application processors). The middleware tier 40 may be comprised of main domain layers, such as domain logic (i.e., business rules) 68 and data access 70. The scalability implied by this architecture approach may be leveraged so that the exemplary system 10 may be scaled to load, without the need to retool. Thus, the system 10 may be embodied across multiple computers and multiple operating systems easily, without the need to substantively redesign the system 10. The system 10 may be developed using a model view presenter (MVP) design pattern. The system software application may be written chiefly in C# .NET (or other suitable language), and may be split into three layers, including UI (view), application (presenter), and domain (model) layers. The Ul layer may present windows forms controls to the user and may delegate processing needs, for example, via event handlers and requests, to corresponding objects of the presenter. The view layer may contain no processing logic related to domain or application layer objects. Application layer classes may handle communications to and from corresponding view classes via interface. Event handlers for corresponding view objects may reside at the presentation layer. Presentation layer objects may handle the delegation of application workflow, validation of user inputs, messaging, and domain layer interface requests. The application layer may also receive requests from ancillary background services for automated testing routines independent of the view. The domain layer may include all classes related to the processing of logical requests regarding information handed down from the application layer or passed back via requests from persistent data store. Corresponding objects at the domain and presenter layers (e.g., algorithmic alignment processing and resultant list objects, slated for view layer display) may interface bi-directionally.

The following section of this disclosure details exemplary systems 10 and exemplary tools 17.

An exemplary sequence alignment tool is generally indicated at 20 in FIG. 13. The sequence alignment tool 20 may enable users to arrange the primary DNA, RNA or protein sequences to identify regions of similarity that may be a consequence of functional, structural, or evolutionary relationships among the sequences. Alignments may tend to be less accurate with rapidly mutating viruses, such as HCV. Thus, algorithms may be included to align any hypervariable regions (e.g. five shown for HCV) separately from the interspersing conserved sequences along the genome, and calculating distances based on the cumulative scores of the combined mutation profile of the infecting genome(s).

The sequence alignment tool 20 may allow a user to: a) choose sequences from a navigation window; b) have the system 10 automatically differentiate between pair-wise and multiple alignment choices based on whether or not the user selects two or more sequences, respectively; c) choose from a variety of appropriate algorithms, scoring matrices, and gap penalty values; d) choose to suppress false negative mutations by selecting from a menu of polymerases purchased from biotech companies (e.g., TaqMan) (an algorithm may incorporate the error rate of the polymerase into the formula); e) select to consider all or a subset of the five hypervariable regions apart from conserved areas for assembly; f) have the program color code various disease specific data points (e.g., glycosylation, phosphorylation, mutation, or user-defined decoration); g) view, save, annotate and export resultant alignments; h) assemble, edit and save alignments or contigs; and/or perform other related tasks.

Custom windows forms user controls, logical domain classes, and database objects to address these tasks may be created. Users may select each sequence in the sequence viewer they wish to align. Once more than a single sequence has been selected in the sequence viewer, an alignment button may be enabled atop the sequence viewer, that when activated may cause a horizontal split container panel to rise and load an instance of a custom user control that may be devoted to collecting alignment parameters. This control may be called, for example, the “alignment designer.”

The alignment designer 73 may comprise a split container, which may be subdivided into two panels, for example, left and right panels. The left panel may contain a list control which may be populated with a list of labels associated with the sequence viewers' selected sequences. To the right of the list control, image button controls (e.g., up and down arrow buttons) may be presented to allow users to reorder sequences at will (these may also allow the user to specify the order in which the sequences may appear in the output). The right panel may contain a list of alignment algorithms from which the user may choose. The list of algorithms may be populated with the names of various local and global, pair-wise and multiple, protein and or nucleotide alignment algorithms. The list of algorithms may be populated in accordance with the number of sequences to be aligned (e.g. if the user chooses two sequences, the user may be presented with a list of the names of any available pair-wise alignment algorithms, whereas, if the user chooses more than two sequences, a list of multiple alignment algorithms may be presented). Once an algorithm is chosen from the list, a list of parameter options may appear below an algorithm drop down list control that may allow users to supply parameters, pertinent to the requirements of the algorithm chosen (e.g., gap penalties, scoring matrices, etc.). Below the algorithmic parameter values, a list of mutation type-specific or other user-defined parameters, such as color coding indicator controls, may be presented, such as in the form of drop down lists with conjoined color picker controls. These parameters may be used by the application to highlight important changes in the RNA and amino acid sequences in the resultant alignment display. Such mutations may include an RNA mutation that confers a functional change to the corresponding amino acid, such that the mutation newly renders the amino acid a target of post-translational modification (e.g., glycosylation or phosphorylation site), or the cause of structural changes in the protein. Once the user has adequately supplied all parameter values, a button entitled “align” may be enabled.

When the user activates this “align” button, the parameter information may be passed to a controller interface 74 through which domain logical processors devoted to conducting the alignment may be invoked. To compliment this process, a progress indicator control window may be created. The progress indicator control window may contain a progress indicator bar, a label control (which may populate with text regarding state of the process) and a cancel button, that when activated, may interrupt and dispose of the current process. A results control 76 may be created. The results control 76 may contain a display of the output of the tool, such as a DataGridView control, and buttons, such as a cancel button and a save button. This control will display the aligned sequences to the user. The user may then activate the cancel button to close the control (thus returning the user to the parameter control) or activate the save button to retain the alignment data. A control may be created to compliment the save action. This control may contain a textbox control that allows the user to name the alignment and navigation means, such as a browse type dropdown list, to allow the user to point to the folder in the record explorer where the alignment record will reside and be presented as an icon with the label data point supplied by the user. The user may have the ability to associate custom annotations with alignment containers and may have the ability to search for those objects via the query tool, as needed.

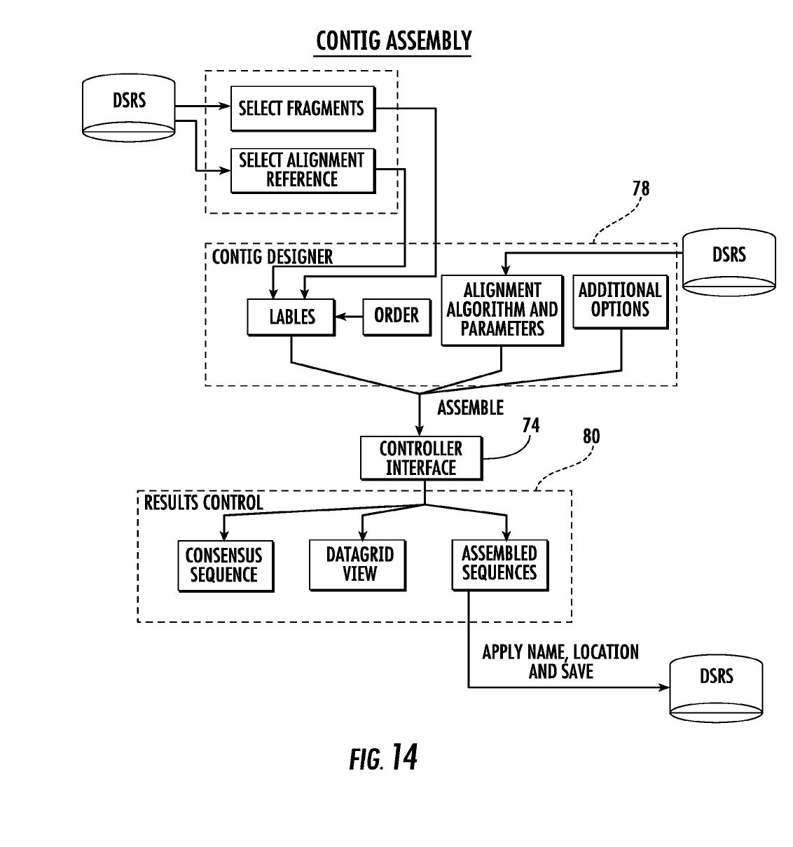

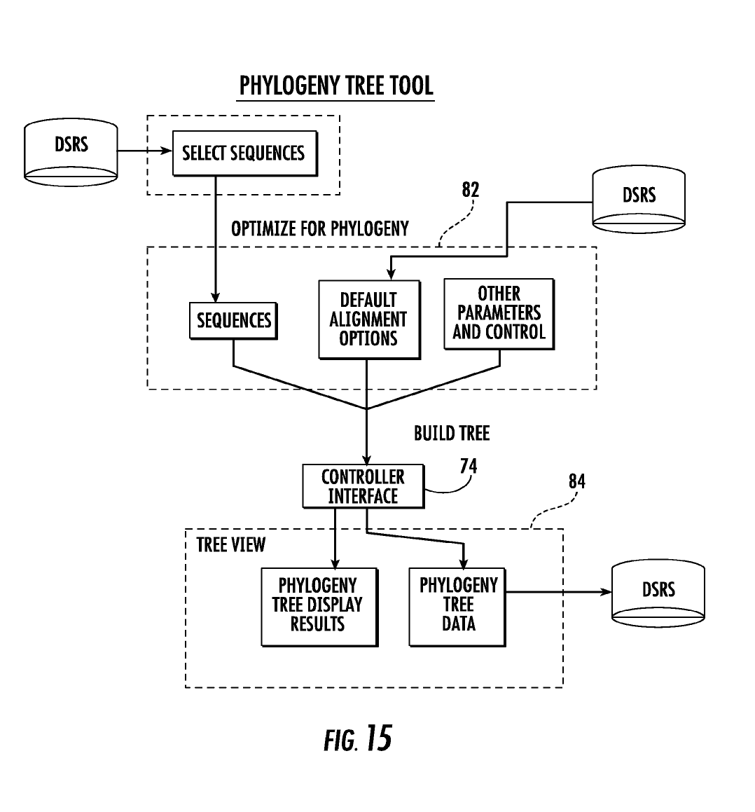

An exemplary contiguous assembly tool (“contig assembly tool”) is generally indicated at 28 in FIG. 14. The contig assembly tool 28 may be an aspect of the alignment tool 20 or be embodied separately. The contig assembly tool 28 may assemble fragment data from sequencing projects of any size, from several to tens of thousands of fragments, into a single consensus sequence. The contig assembly tool 28 may be designed to allow a user to: a) submit sequence fragments to the alignment tool 20 for multiple alignment; b) submit a reference sequence for the contig assembler to align fragments against; c) design a contig assembly project to identify and remove unreliable data, including poor quality 3′ or 5′ ends, sub-minimal length reads, and vector sequences; d) save the resultant consensus sequence; and e) recall the saved sequence for parameter manipulation and re-assembly; and/or other related tasks.

Custom windows forms user controls, logical domain classes, and database objects to address these requirements may be created. Users may select a set of fragments from a sequence bank object in the record explorer 48 that may, in turn, populate the sequence viewer 51 with the fragments stored, therein. Users may also choose a sequence to use as an alignment reference. Users may select each sequence in the sequence viewer 51 they may wish to use for contig assembly tool 28. Once more than a single sequence has been selected in the sequence viewer 51, a contig designer button may be enabled atop the sequence viewer 51, that when activated may cause a horizontal split container panel to rise and load an instance of a custom user control that may be devoted to collecting contig assembly parameters. This control may be called “Contig Designer”. The contig designer 78 may use much of the same features as the alignment designer tool; this is because contigs may first be aligned to a reference sequence before being consolidated into a contiguous sequence.

The contig designer 78 may include a split container, which may be subdivided into panels, for example, left and right panels. The left panel may contain a list control which may be populated with a list of labels associated with sequence viewers, selected fragment sequences and reference sequence. To the right of the list control, image button controls (e.g., up and down arrow buttons) may be presented to allow users to reorder sequences at will (these may also allow the user to specify the order the sequences may appear in the contig preassembly, alignment (scan) output). The right panel may contain a list of multiple alignment algorithms from which the user may choose. Once an algorithm is chosen from the list, a list of parameter options may appear below the algorithm drop down list control that may allow users to supply parameters, pertinent to the requirements of the algorithm chosen (e.g., gap penalties, scoring matrices, etc.). A default configuration for optimal contig preassembly alignment may be configured (e.g., no penalties for end gaps, high internal gap costs, short match with high score/residue). Below the algorithmic parameter values, a list of checkboxes may be presented. These checkboxes may be associated with additional preassembly options for the user to choose from, such as a) automatic removal of vector sequence(s) (strongly recommended when using Sanger data); b) removal of contaminant sequence(s); c) identification of repetitive sequence(s); d) automatic 5′ and 3′ end trimming; e) manual end setting; f) allowing the assembler to optimize the order in which it assembles fragments; and/or other related options. Once the user has completed the assembly design, a button entitled “Assemble” may be enabled. When the user activates the “Assemble” button, the parameter information may be passed to a controller interface 74 through which domain logical processors devoted to conducting the multiple alignment and subsequent consensus sequence assembly may be invoked. To compliment this process, a progress indicator control window may be provided. The progress indicator control window may include a progress indicator bar, a label control (which may populate with text regarding state of the process) and a cancel button, which when activated may interrupt and dispose of the assembly process. A results control 80 may be provided. The results control 80 may include a display of the results of the contig assembly tool 28, such as a text box, DataGridView control, as well as functional buttons, such as a cancel button and a save button. The text box may be populated with the consensus sequence. The text box may be scrollable (e.g., left and right). The DataGridView will contain all aligned sequence fragments. The user may then activate the cancel button to close the control (thus returning the user to the contig designer) or activate the save button to retain the results of the contig assembly tool 28. A control may be provided to compliment the save action. The control may include a textbox control that allows the user to name the alignment and a navigation means, such as a browse type dropdown list, to allow the user to point to the folder in the record explorer 48 where the assembly record may reside and be presented as an icon with the label data point supplied by the user. The user may have the ability to associate custom annotations with alignment containers and may have the ability to search for those objects via the query tool 26, as needed.

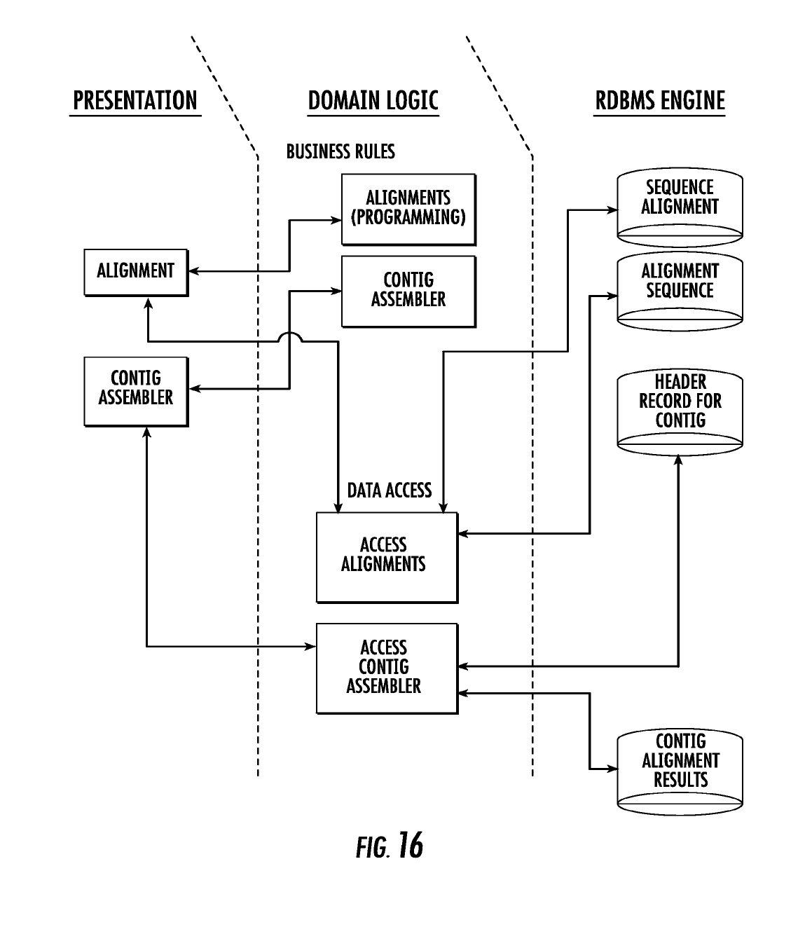

An exemplary phylogeny tool is generally indicted at 22 in FIG. 15. The phylogeny tool 22 may assemble the specialized alignments that consider the hypervariable regions into evolutionary trees, and that may color-code and timestamp the input sequences according to desired aspects, such as quasi- species from single patient or clonal samples. An exemplary phylogeny tool 22 may allow a user to: a) design and conduct a multiple alignment as described by the alignment steps disclosed above; b) color code sequences or regions of sequences for easy tracking of quasi-species by mutation type or regions under selective pressure in a single patient or clone from the tree; c) create and graphically display rooted phylogeny trees; d) save resultant trees in a discernable format, such as the PAUP (*.pau or *.nex) format; and/or other related tasks.

Custom windows forms user controls, logical domain classes, and database objects to address these requirements may be created. Users may select sequences from the sequence viewer 51 for alignment design (as described above). The right hand split container of the alignment designer 73 may include a button control called “optimize for phylogeny.” When a user clicks this button, default alignment options may populate the designer's input parameters, choosing the alignment algorithm best suited for the phylogeny tree build (e.g., ClustaIV) and automatically populating associated parameter controls with values optimized for phylogeny building (see the phylogeny optimizer 82 in FIG. 15). Additional parameter controls may be created and rendered (such as color pickers for easy tracking of quasi-species). After all required alignment parameters are populated, a button called “Build Tree” may be enabled. When the user activates the “Build Tree” button, the parameter information may be passed to a controller interface 74 through which domain logical processors devoted to conducting the multiple alignment and subsequent tree assembly may be invoked. To compliment this process, a progress indicator control window may be created. This control may contain a progress indicator bar, a label control (which may populate with text regarding state of the process) and a cancel button, that when activated, may interrupt and dispose of the tree build process. A custom user control 84 called “tree view” may be created. This control 84 may instantiate a custom control that may render the results of the tree build process. Windows drawing objects or other similar means may be used to accomplish the creation of this control output. Color coding options may display in accordance with user input parameters (where applicable). Options may be available to retain and save the results of the tree build process.

Corresponding domain objects may be created, for example, in C#, to facilitate the processing of the various tools. Domain logic may be subdivided into categories, for example, business rules 68 and data access 70. Corresponding objects related to each portion of the various tools may be created at the domain level, for example, one for business rules 68 and the other for data access 70.

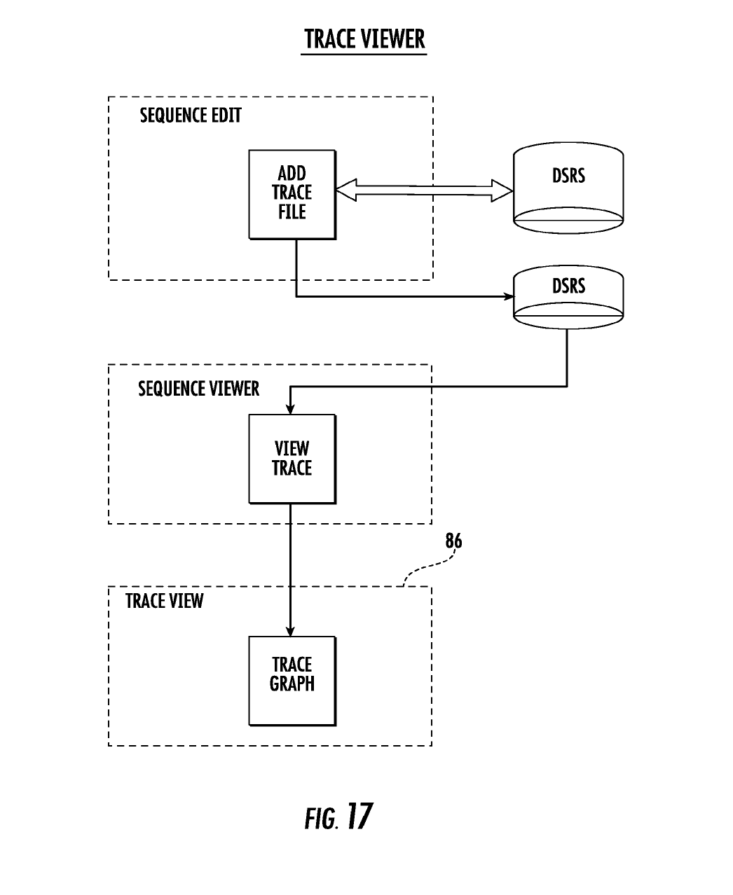

In the exemplary system generally indicated at 10 in FIG. 16, a business rule object named “Alignments” may be created to handle requests on behalf of the complimentary application layer object, which may also be named “Alignments.”. A data access object may be created named “AccessAlignments” to handle database interaction on behalf of the “Alignments” domain object requests. The “Alignments” object may be comprised of properties to get and set the alignment designer input, properties that may contain the results of an alignment, methods for conducting alignments or methods that interface with third party components which process alignments and return results. The “AccessAlignments” object may include methods that contain RDBMS brand specific DML which may facilitate the saving and retrieval of persistent input to and output from the RDBMS engine 44. A business rules object named “ConfigAssembler” may be created, to handle requests on behalf of the complimentary application layer object, also called “Alignments”. A data access object named “AccessConfigAssembler” may be created to handle database interaction on behalf of the “ConfigAssembler” domain object requests. The “ConfigAssembler” object may be comprised of properties to get and set the Contig designer input, properties that may contain the results of contig project executions, methods for conducting alignments or methods that interface with third party components which process alignments and return results, and methods to assemble the contiguous consensus sequence. The “AccessAlignments” object may contain methods that may contain RDBMS brand specific DML which may facilitate the saving and retrieval of persistent input to and output from the RDBMS engine 44.

A supporting data model 72 may include multiple entities. In an exemplary system 10, the data model 72 is comprised of four entities. The first entity may be called “sequence alignment” and may be used to store the header record of the sequence alignment. It may include the following fields: primary key/identity field (UIP), a name field (label), and a parameter/header field (params). The second entity may be called “alignment sequence” and may store pointers to the individual sequences that make up the alignment and the sequence as aligned. It may include a primary key/identity field (UIP), a foreign key field (seq_align_uid), the UIP of the sequence row as stored in the sequence table (sequence_uid), and a field to contain the sequence as it appears in the alignment results. The third entity may be a header record for the contig assembly session and it may include a primary key/identity field (UIP), a name field (label), and a parameter/header field (params). The fourth entity may contain the contig alignment results and it may have the following fields: a primary key/identity field (UIP), a foreign key field (contig_assembly_uid), the UIP of the sequence row as stored in the sequence table and a flag that may be used as a tri-state indicator to let the system know whether or not the sequence is a fragment, contig, or reference.

In an exemplary system 10, a business rule object named “PhyloTree” may be created, for example, to handle requests on behalf of the complimentary application layer object, also named “PhyloTree”. A data access object named “AccessPhyloTree” may be created to handle database interaction on behalf of the “Phylotree's” domain object requests. The “PhyloTree” object may be comprised of properties to get and set the alignment designer input, properties that may include the results of an alignment, methods for conducting alignments, and methods for producing the phylogenie tree (e.g. neighbor joining) The “AccessPhyloTree” object may include methods that include RDBMS brand specific DML which may facilitate the storage and retrieval of persistent data to and from the RDBMS 44.

A supporting data model 72 may comprise multiple entities. In an exemplary system 10, the supporting data model 72 may comprise two entities. A first entity may be called “phylo sequence alignment,” and it may be used to store the header record of the initial sequence alignment and the resultant tree. It may contain the following fields: primary key/identity field (UIP), a name field (label), an alignment parameter/header field (alignment_params), and a second parameter/header field (phylo_params).

A second entity may be called “phylo sequence” and may store pointers to the individual sequences that may make up the initial alignment. It may contain a primary key/identity field (UIP), a foreign key field (seq_align_uid), the UIP of the sequence row as stored in the sequence table (sequence_uid), and a field to include the sequences as they appear in the preliminary multiple alignment results.

Graphics tools may be developed to aid the researcher in the analysis of HCV data. Graphics tools may present the raw electropherogram data (traces), and assemble line and bar graphs to plot up to two variables. Graphics tools may enable a user to store and view trace files associated with their sequences and to have the application assemble line and bar graphs to plot up to two variables.

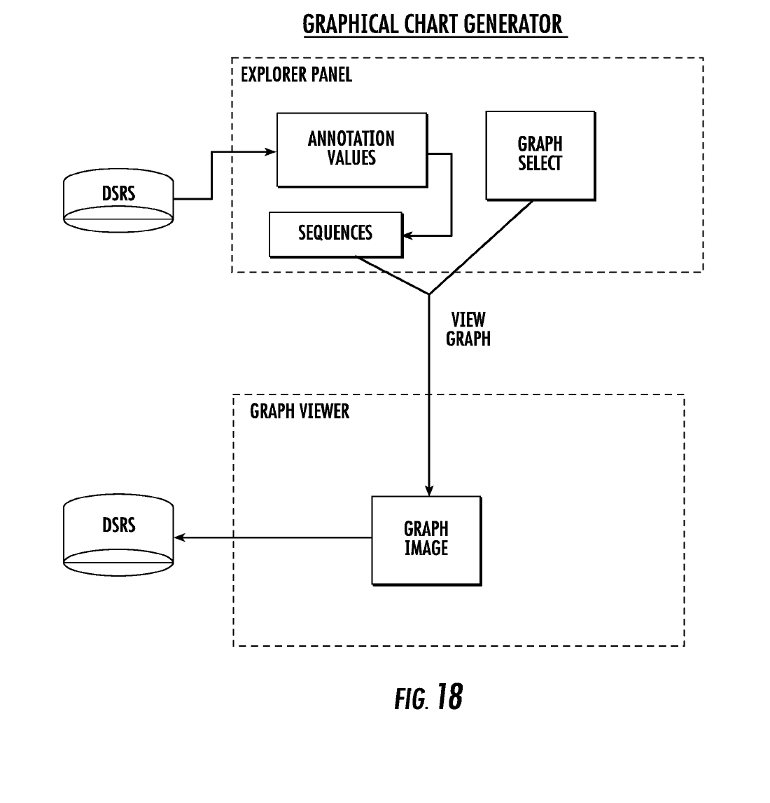

Custom user controls may allow users to accomplish these tasks. A first control may be a trace viewer, shown in FIG. 17, and a second may be a graphical chart generator, shown in FIG. 18.

A windows forms control may allow users to view chromatogram trace files, associated with sequences submitted to the system. The sequences edit and add tools may be enhanced to allow the storage of trace files. In an exemplary system 10, a button control called “add trace file” may be added to the sequence edit control 51. When a user activates this button, a windows file system dialogue window may appear, prompting the user to choose the location of the trace file from the local file system or over the network. Once the user locates the trace file to be associated with the sequence, the user may select that file. Upon doing so, the file system dialogue window may close and the trace file path may be supplied to a domain method which may pass the contents of the file and the full path into the properties of the sequence to be saved. The user may then activate a save button to save the data; the sequence may be updated and the edit sequence window may close. The sequence row as represented in the sequence viewer 51 may be update to include an icon, indicating that the sequence record includes a corresponding trace file. When the user activates this icon, the trace file viewer window may appear.

A custom user control called “trace view” 86 may instantiate a custom control that may read and interpret the trace file. Windows drawing objects maybe used to accomplish the creation of this control output. Classes to interpret each type of supported trace file (such as ABI and SCF) and paint its sequence (color coded, such as by nucleotide) and corresponding trace graph (color coded, such as by nucleotide) may be created. Users may be able to scroll left and right to view the trace in full.

Custom window forms controls may allow users to view graphs, related to specialized, virus (e.g. HCV) specific custom annotation values associated with sequences in the system. Check box controls may be added in the annotation explorer panel, associated with particular annotations that may be common to all sequences in the view. These annotations may share a common data type. Once the common annotations are selected, a radio button control with two list items may be enabled, one for example labeled “line graph”, the other labeled “bar chart” and a button control entitled “view graph” may be enabled. Upon selecting either a radio button and activating the “view graph” button, a new window called “graph viewer” may pop up. This window may contain a custom image control that may display the resultant graph image, rendered by the system in accordance with the data points supplied by the common sequence annotation record values and an export button to allow the user to save the resultant image to the file system (for export to other programs and formats, such as Excel or PowerPoint).

Corresponding domain objects in C# may facilitate the processing of the abovementioned tools. Domain logic may be subdivided into categories, for example, business rules 68 and data access 70. Corresponding objects related to each tool may be created at the domain level, for example, one for business rules 68 and the other for data access 70. In an exemplary system 10, a business rule 68 object named “Trace” may be included to handle requests on behalf of the complimentary application layer object, also named “Trace.” A data access object may be named “AccessTrace” may handle database interaction on behalf of the “Trace” domain object requests (namely, to retrieve the binary trace data from the sequence record). The domain logic “Trace” object may be comprised of properties to get and set trace view parameter (such as, color coding of nucleotides and sign waves) and methods to introspect the binary data points and interact with windows drawing objects to create the visual trace output. The “AccessTrace” object may include methods that contain RDBMS brand specific DML which may facilitate the saving and retrieval of persistent input to and output from the RDBMS engine 44 related to the trace file associated with a sequence. A business rule object may handle the interpretation of the graph data, and to render the results of the process into a bitmap file for display and export.

There is a fundamental void of understanding about how the numerous viral (e.g., HCV) variants impact the host's genomic response. To gauge this response, researchers examine the infected host genome at the transcription level by analyzing their gene expression profiles using microarray technologies. The system 10 may incorporate a database for microarray data from, for example, 50,000 transcripts and can link the viral (e.g., HCV) sequences directly to a host microarray profile. The system 10 may also enable normalization of microarray chip data generated from different chemical platforms (e.g. two-color systems, lithographic synthesis, etc). The viral (e.g., HCV) protein and microarray files are linked with a common ID number. The system 10 may maintain the relational hierarchy with ongoing exploration capabilities. Also, the system 10 may implement a lateral linkage ability so that the user has the option of linking or not linking subsequent expression and sequence data.

A genotyping tool may identify the genotype and serotype of an incoming sequence by comparing (e.g., three) small nucleotide domains in (e.g., three) regions (e.g., “C/E1/NS5B/5′UTR” in HCV) in a genotype/serotype-specific viral reference sequence with an incoming virus genome. This genotyping strategy, based upon the conservation findings of Murphy et al. (2007) it is highly accurate, distinguishes all known virus serotypes (e.g., n=77 in HCV) and represents the latest in virus identification over all other methods. The genotyping tool may use a sequence orientation schema that relies upon the conserved regions for orientation and identification to one domain (e.g., NS5B in HCV), then another domain (e.g., C/E1 in HCV) and until finally, the last domain (e.g., 5′UTR in HCV). This multi-tiered (e.g., three tiered) validation approach may ensure approximately 90% accuracy of genotype/serotype identification. This tool may be readily modifiable to genotype and serotype other viral sequences as well.

It is understood in the art that any above mentioned usage of windows form controls may be enacted by various other similar programming means and on other operating platforms.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A system for management of virus data, the system comprising:
one or more graphical-user interface (GUI) tools and a data-storage;
retrieval system (DSRS), wherein the DSRS stores genetic, biological, clinical, and phenotypic virus data and the one or more GUI tools operate to effect control of the system to manage and analyze the data, and wherein the one or more GUI tools and the DSRS are integrated for the management of the virus data without exporting data; and
an import tool that automates a task of separating one or more virus sequences into at least one of individual proteins and regions.

2. A system for management of virus data, the system comprising:
one or more graphical-user interface (GUI) tools;
a data-storage and retrieval system (DSRS), wherein the DSRS stores genetic, biological, clinical, and phenotypic virus data and the one or more GUI tools operate to effect control of the system to manage and analyze the data and wherein the one or more GUI tools and the DSRS are integrated for the for management of the virus data without exporting data; and
a phylogeny tool that assembles alignments into evolutionary trees that color-code and time-stamp data sequences.

3. A genomic data management system, comprising:
a data-storage and retrieval system enabled to store genetic, biological, clinical, phenotypic, experimental, and microarray genomic data, an analysis system capable of accessing the genetic, biological, clinical, phenotypic, experimental, and microarray genomic data of the data-storage and retrieval system, the analysis system comprising:
an annotation tool capable of creating user-defined data points in association with experimental data points,
an alignment tool specifically tailored to the mathematics of a targeted virus and including a contig assembler and capable of creating alignments specific to the targeted virus,
a phylogeny tool interconnected with the alignment tool and capable of producing phylogenetic trees and being specifically tailored to the mathematics of the targeted virus and capable of assembling the alignments into color-coded and time-stamped evolutionary trees,
a mutation analysis tool specifically tailored to the mathematics of the targeted virus, and
a query tool capable of querying genomic, clinical, and experimental data, as well as the user-defined data points associated with the experimental data points.

4. The system of claim 3, wherein the targeted virus is the Hepatitis C Virus.

5. The system of claim 4, wherein the data-storage and retrieval system is designed to specifically track various biological parameters associated with HCV.

6. The system of claim 3, wherein the phylogeny tool is interconnected with a mutation tracking tool and an entropy tool, and uses statistical procedures to quantify a degree of virus variation within and among quasi-species sequences.

7. The system of claim 3, wherein the phylogeny tool is interconnected with a mutation tracking tool and is capable of determining an evolutionary rate of a set of mutation types of the targeted virus.

8. The system of claim 7, wherein the phylogeny tool is additionally interconnected with an entropy tool, and wherein the analysis system is capable of using the phylogeny tool, the mutation tracking tool, and the entropy tool to provide analysis data related to at least one or more of:
quasi-species distributions and virus eradication,
genetic heterogeneity among anti-viral responders and non-responders, whether virus quasi-species shuffle resistance mutations within or among virus genes to increase diversity to drug resistant genotypes, and
the covariance of the infecting genotypes.

9. The system of claim 3, wherein the data-storage and retrieval system is operatively connected to a sequencing machine to import sequencing data without generating files outside of the data-storage and retrieval system.

10. The system of claim 3, wherein the query tool is capable of simultaneously querying genomic, clinical, and experimental data, as well as the user-defined data points associated with the experimental data points.

11. The system of claim 3, wherein the alignment tool is interconnected to the query tool such that a set of query attributes are highlighted when viewing an alignment.

12. The system of claim 3, wherein the alignment tool is designed to align hypervariable regions of the targeted virus separately from the conserved regions.

13. The system of claim 3, wherein the color-coding of the phylogeny tool is designed to color code different quasi-species of the targeted virus.

14. The system of claim 3, wherein the data-storage and retrieval system and the analysis system are configured to link sequences from the targeted virus directly to a host microarray profile.

15. The system of claim 3, additionally comprising a sequencing machine capable of generating a set of live sequencing data, wherein the data-storage and retrieval system is capable of accessing and storing the set of live sequencing data.

16. The system of claim 3, wherein the analysis system is implemented through a graphical user interface (GUI) that includes a set of GUI tools, comprising:
a GUI alignment tool for interfacing with the alignment tool,
a GUI phylogeny tool for interfacing with the phylogeny tool,
a GUI mutation analysis tool for interfacing with the mutation analysis tool,
a GUI query tool for interfacing with the query tool,\a graphics tool configured to present raw electropherogram data, and
a GUI annotation tool for interfacing with the annotation tool and capable of creating annotations in connection with the other tools of the set of GUI tools.

17. The system of claim 3, wherein the annotation tool manages annotations in the form of user defined data points and integrates the annotations into a searchable context that is inherent to the system.

18. A genomic data management system, comprising:
a data-storage and retrieval system enabled to store genetic, biological, clinical, phenotypic, experimental, and microarray genomic data, and specifically designed to track various biological parameters associated with a targeted virus; and
an analysis system capable of accessing the genetic, biological, clinical, phenotypic, experimental, and microarray genomic data of the data-storage and retrieval system, the analysis system comprising a set of interconnected analysis tools, the set of interconnected analysis tools comprising:
an annotation tool capable of creating user-defined data points in association with experimental data points,
an alignment tool specifically tailored to the mathematics of the targeted virus and including a contig assembler and capable of creating alignments specific to the targeted virus,
a phylogeny tool capable of producing phylogenetic trees and being specifically tailored to the mathematics of the targeted virus and capable of assembling the alignments into color-coded and time-stamped evolutionary trees,
a mutation analysis tool specifically tailored to the mathematics of the the targeted virus, and
a query tool capable of querying genomic, clinical, and experimental data, as well as the user-defined data points associated with the experimental data points,
wherein the targeted virus is a rapidly reproducing virus with a high mutation rate.

19. The system of claim 18, wherein the targeted virus contains an RNA genome.

20. The system of claim 19, wherein the RNA genome has one or more hypervariable regions.

21. The system of claim 19, wherein the phylogeny tool is interconnected with a mutation tracking tool and an entropy tool, and wherein the analysis system is capable of using the phylogeny tool, the mutation tracking tool, and the entropy tool to provide analysis data related to at least one or more of:
quasi-species distributions and virus eradication,
genetic heterogeneity among anti-viral responders and non-responders, whether virus quasi-species shuffle resistance mutations within or
among virus genes to increase diversity to drug resistant genotypes, and
the covariance of the infecting genotypes.

22. The system of claim 21, wherein the alignment tool is designed to align hypervariable regions of the targeted virus separately from the conserved regions.

23. The system of claim 22, wherein the targeted virus is the Hepatitis C Virus.

24. The system of claim 23, additionally comprising a sequencing machine capable of generating a set of live sequencing data, wherein the data-storage and retrieval system is capable of accessing and storing the set of live sequencing data.

25. The system of claim 21, wherein the annotation tool manages annotations in the form of user defined data points and integrates the annotations into a searchable context that is inherent to the system.
